(19) United States
(12) Patent Application Publication
(10) Pub. No.: US 2021/0231998 A1
(43) Pub. Date: Jul. 29, 2021

(54) DISPLAY APPARATUS

(71) Applicant: CANON KABUSHIKI KAISHA, Tokyo (JP)

(72) Inventors: Shinnosuke Noso, Tokyo (JP); Ryo Ohtomo, Kanagawa (JP); Takuma Kanno, Tokyo (JP); Masahiro Kamiyoshihara, Kanagawa (JP); Tetsuya Ishida, Kanagawa (JP); Yasuhiro Matsuura, Kanagawa (JP); Jun Kawata, Kanagawa (JP); Tomonori Nakazawa, Kanagawa (JP)

(21) Appl. No.: 17/160,027

(22) Filed: Jan. 27, 2021

(30) Foreign Application Priority Data
Jan. 29, 2020 (JP) 2020-012299

(51) Int. Cl. G02F 1/1333; G02F 1/1335; G02F 1/1345

(52) U.S. Cl. CPC G02F 1/133308; G02F 1/133385; G02F 1/13452; G02F 1/133553

(57) ABSTRACT

A display apparatus includes: a display panel configured to transmit light applied to a back side thereof to display an image; an optical member provided behind the back side of the display panel such that a first space is formed between the display panel and the optical member; a light-emitting member provided behind a back side of the optical member to apply light to the back side of the display panel through the optical member; and a flow-path forming member forming a flow path that allows air to flow from one of outside of the display apparatus and a part of the first space corresponding to at least one of four outer edges of the display panel to the other.

### BACKGROUND OF THE INVENTION

### Field of the Invention

The present invention relates to a display apparatus.

### Description of the Related Art

In recent years, more display apparatuses are equipped with high-definition display panels having a horizontal resolution (pixel count) of approximately 4,000 pixels, or so-called 4K displays. Further, ultra-high-definition display panels with a horizontal resolution of approximately 8,000 pixels, or so-called 8K displays, are beginning to be adopted. When a liquid crystal panel is used as such display panels, the brightness of the backlight needs to be increased to compensate for the reduced light transmittance caused by the higher definition.

Additionally, display apparatuses have been introduced that support high-dynamic-range (HDR) imaging, which is a technique that represents a wider range of brightness levels that can be recorded in images. When a liquid crystal panel is used as a display panel, the backlight needs to provide a higher brightness to increase the maximum brightness to be displayed. More specifically, the display panel, which transmits the light from the backlight, needs to provide a brightness of 1,000 cd/m² or more.

In a high-brightness backlight, the increased electric power for a light-source board increases the amount of heat generated by the light-source board itself, and an optical-sheet group and a display panel, which transmit the light of the backlight, absorb light and thus generate heat, resulting in a problem of a high temperature of a display module.

A display module is typically sealed for dust prevention, and its heat is dissipated by cooling the back side of the display module. Japanese Patent Application Laid-open No. 2017-514156 discloses a configuration in which an intake and discharge port and a fan are provided on respective sides of the display module to form flow paths in the display module for heat dissipation.

However, the conventional technique of Japanese Patent Application Laid-open No. 2017-514156 mainly ventilates the areas where the fans are located, failing to perform the heat dissipation and cooling of the whole display module. This technique would require a large number of fans to achieve the heat dissipation and cooling of the whole display module.

### SUMMARY OF THE INVENTION

The present invention provides a technique to efficiently dissipate heat in a display apparatus.

The present invention in its first aspect provides
a display apparatus comprising:
a display panel configured to transmit light applied to a back side thereof to display an image;
an optical member provided behind the back side of the display panel such that a first space is formed between the display panel and the optical member;
a light-emitting member provided behind a back side of the optical member to apply light to the back side of the display panel through the optical member; and
a flow-path forming member forming a flow path that allows air to flow from one of outside of the display apparatus and a part of the first space corresponding to at least one of four outer edges of the display panel to the other.

Further features of the present invention will become apparent from the following description of exemplary embodiments with reference to the attached drawings.

### BRIEF DESCRIPTION OF THE DRAWINGS

FIG. 1 is an exploded perspective view of a display apparatus of a first embodiment;

FIG. 2 is a front view of a display panel and a ventilation member of the first embodiment;

FIG. 3A is a cross-sectional view of the display apparatus of the first embodiment;

FIG. 3B is a cross-sectional view of the display apparatus of the first embodiment;

FIG. 4 is a front view of the display apparatus of the first embodiment;

FIG. 5 is a cross-sectional view of a display apparatus of the first embodiment;

FIG. 6 is a cross-sectional view of a display apparatus of the first embodiment; and

FIG. 7 is a front view of the display panel of the first embodiment.

FIG. 8 is a front view of a display panel of a second embodiment;

FIG. 9 is a front view of a display panel of a third embodiment;

FIG. 10 is a cross-sectional view of a display apparatus of the third embodiment;

FIG. 11 is a front view of partitions of the third embodiment;

FIG. 12A is a cross-sectional view of the display apparatus of the fourth embodiment;

FIG. 12B is a cross-sectional view of the display apparatus of the fourth embodiment;

FIG. 12C is a cross-sectional view of the display apparatus of the fourth embodiment;

FIG. 12D is a cross-sectional view of the display apparatus of the fourth embodiment;

FIG. 12E is a cross-sectional view of the display apparatus of the fourth embodiment;

FIG. 13 is a front view of a display panel and a ventilation member of the fourth embodiment;

FIG. 14 is a functional block diagram illustrating valve opening and closing of the fourth embodiment;

FIG. 15 is a cross-sectional view of a display apparatus of a fifth embodiment;

FIG. 16 is a cross-sectional view of the display apparatus of the fifth embodiment;

FIG. 17A is a cross-sectional view of a display apparatus of a sixth embodiment;

FIG. 17B is a cross-sectional view of the display apparatus of the sixth embodiment;

FIG. 18A is a cross-sectional view of a display apparatus of a seventh embodiment;

FIG. 18B is a cross-sectional view of a display apparatus of the seventh embodiment;

FIG. 19A is a cross-sectional view of a display apparatus of an eighth embodiment:

FIG. 19B is a cross-sectional view of the display apparatus of the eighth embodiment; and

FIG. 20 is a cross-sectional view of a display apparatus of a ninth embodiment.

### DESCRIPTION OF THE EMBODIMENTS

### First Embodiment

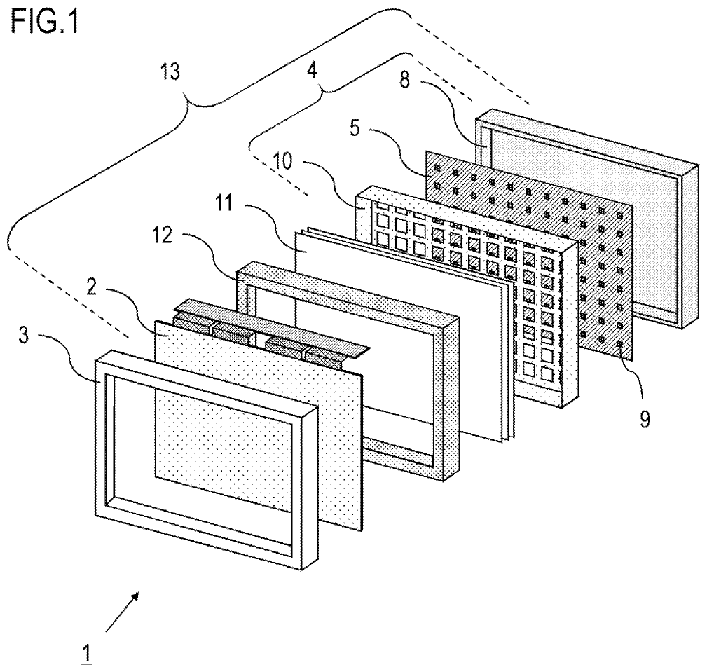

Referring to FIGS. 1 to 6, a display apparatus 1 of a first embodiment is now described. FIG. 1 is an exploded perspective view of the display apparatus 1 of the first embodiment. The display apparatus 1 of the present embodiment is a liquid crystal display including components such as a liquid crystal panel (display panel) and light sources (light-emitting members).

The display apparatus 1 includes a bezel 3, which is a front exterior member, and a display module 13. The display module 13, which is provided behind the bezel 3, is a unit for displaying images. The display apparatus 1 also includes other components (not shown) behind the display module 13, such as an electric circuit board for driving, an internal structural components, and a rear cover serving as a back exterior member.

The bezel 3 is formed by molding metal, such as aluminum or iron, or resin. The display module 13 has components including a display panel 2, a panel holder 12, an optical-sheet group 11 (optical member), and a backlight 4. The display panel 2 has a display area for displaying an image on the front side. The panel holder 12 holds the optical-sheet group 11 and is fixed to the backlight 4. The panel holder 12 and the bezel 3 on the front side sandwich the display panel 2 for fixing. The panel holder 12 functions to hold the optical-sheet group 11 and support the display panel 2. The panel holder 12 is preferably resin-molded, but may be made of a metal material. The panel holder 12 holds and stores the display panel 2 such that a certain clearance is maintained between the optical-sheet group 11 and the display panel 2.

The backlight 4 may include a case 8, a light-source board 5, and a reflective sheet 10, which are arranged in this order from the back. The case 8 is a member for housing the optical-sheet group 11, the reflective sheet 10, and the light-source board 5. The case 8 is preferably formed of a metal material by press working or machining in consideration of the strength and the heat dissipation of the light sources 9, which provide high brightness associated with HDR. In particular, the section that is in contact with the light-source board is preferably made of an alloy of materials with a high thermal conductivity, such as iron, aluminum, or copper.

A plurality of light sources 9 is mounted on the light-source board 5. The light sources 9 of the present embodiment are light emitting diodes (LEDs), but not limited to this. The reflective sheet 10 is a reflective member for efficiently reflecting the light emitted from the light source 9 toward the optical-sheet group 11. The reflective sheet 10 is surface-treated with a material having a high reflectance. Specifically, a white foamed PET sheet or a thin metal plate having a highly reflective film on the surface may be used. The reflective sheet 10 preferably has a thickness of about 0.1 mm to 2.0 mm, but the thickness is not limited to this value.

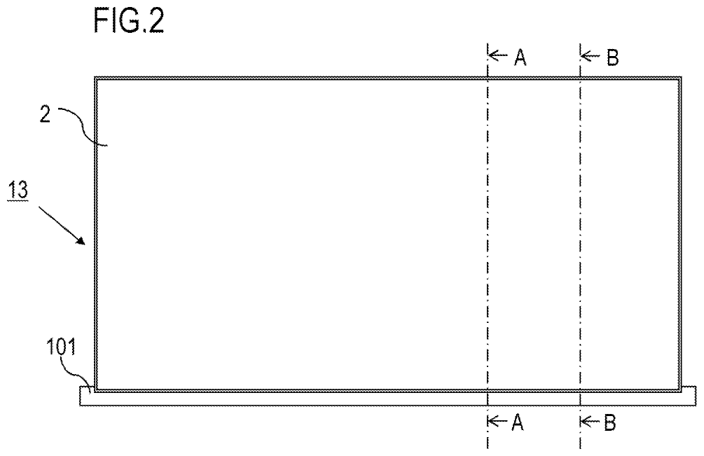

FIG. 2 is a front view of the display panel 2 and a ventilation member 101 (flow-path forming member) of the first embodiment. In this embodiment, the ventilation member 101 is provided along the lower edge of the display module 13. The ventilation member 101 is fixed to the case 8 (not shown).

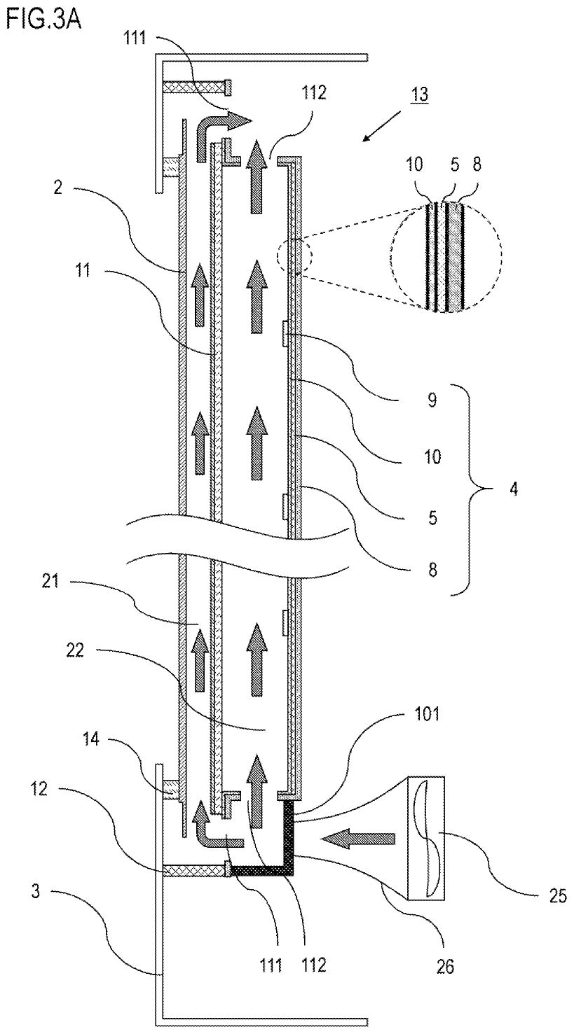

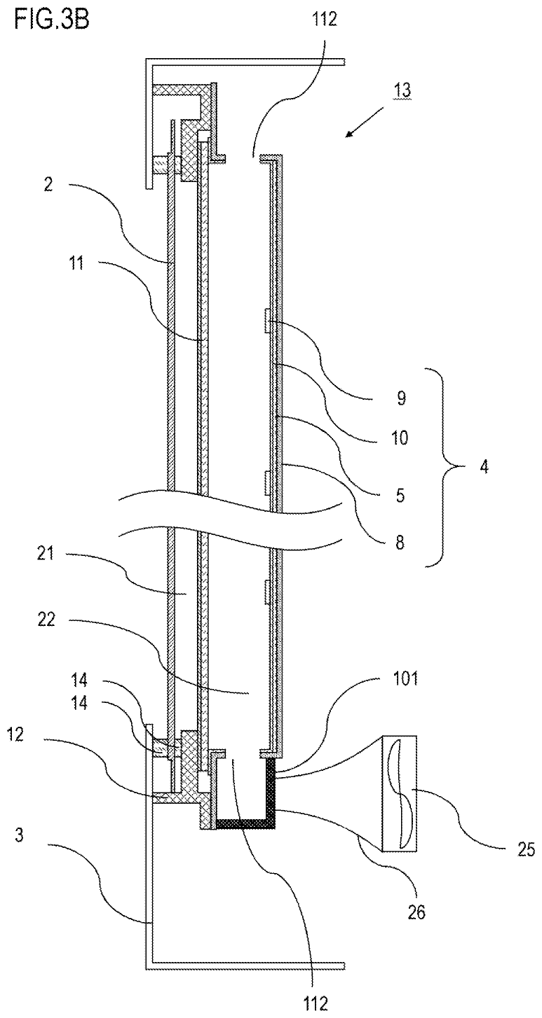

FIG. 3A is a cross-sectional view of the display apparatus 1 of the first embodiment, taken along line A-A in FIG. 2. In the display apparatus of the first embodiment, a first space 21 is formed between the display panel 2 and the optical-sheet group 11, and a second space 22 is formed between the backlight 4 and the optical-sheet group 11. A first vent hole 111 and a second vent hole 112 are formed in each of the upper and lower edge sections of the backlight 4. Each first vent hole 111 extends through the case 8, the reflective sheet 10, the optical-sheet group 11, and the panel holder 12 and communicates with the first space 21. That is, the first vent hole 111 provides communication between a part of the first space 21 that corresponds at least to one of the four outer edges of the display panel 2 and the internal space of the ventilation member 101. Each second vent hole 112 extends through the case 8 and the reflective sheet 10 and communicates with the second space 22. A flexible component cushion 14 is provided between the display panel 2 and the bezel 3. Further, since the panel holder 12 is arranged on the bezel 3 without forming a gap in between, the air moving through the first vent hole 111 flows into the first space 21 without leaking. Alternatively, one of the first and second vent holes 111 and 112 may be closed so that air flows only into one of the first and second spaces 21 and 22.

The ventilation member 101 forms a hollow structure when fixed to the case 8. The ventilation member 101 preferably has an L-shaped (FIG. 3A) or square cross-section. When the ventilation member 101 has a square cross-section, the ventilation member 101 may have openings communicating with the first and second vent holes 111 and 112. The ventilation member 101 may be made of a metal material, such as iron or aluminum, or a resin material. Further, the case 8 and the ventilation member 101 may be integrally formed as a single component.

A fan 25 and a fan-coupling member 26 are connected to the ventilation member 101. The fan 25 is preferably a sirocco fan, but the type of fan is not limited to this. The fan 25 may be an axial fan, for example. The air discharged by the fan 25 is sent into the ventilation member 101. The fan-coupling member 26 is a hollow member forming a flow passage connecting the ventilation member 101 to the suction or discharge port of the fan 25, and is made of metal, resin, or other material.

The fan-coupling member 26 may have any length and shape. The ventilation member 101 and the fan-coupling member 26 may be integrally formed as a single component. Further, a plurality of fans 25 and fan-coupling members 26 may be provided. The fan 25 and the fan-coupling member 26 are preferably arranged at an end of the ventilation member 101 for reasons including the ease of arranging the fan 25, a fewer number of fans 25 required, and a simple flow-path configuration in the ventilation member 101. Nevertheless, the fan 25 may be connected to any position, such as a position near the center of the ventilation member 101. In one preferred example, the fan 25 is housed in the cabinet of the display apparatus 1 at the back side and connected to the ventilation member 101 by a fan-coupling member 26 extending in the front-rear direction of the cabinet of the display apparatus 1.

FIG. 3B is a cross-sectional view of the display apparatus 1 of the first embodiment, taken along line B-B in FIG. 2. The panel holder 12 has a different cross-sectional shape in this B-B cross-section, and the display panel 2 is sandwiched between the panel holder 12 and the bezel 3. Further, the panel holder 12 receives and supports the lower end of the display panel 2.

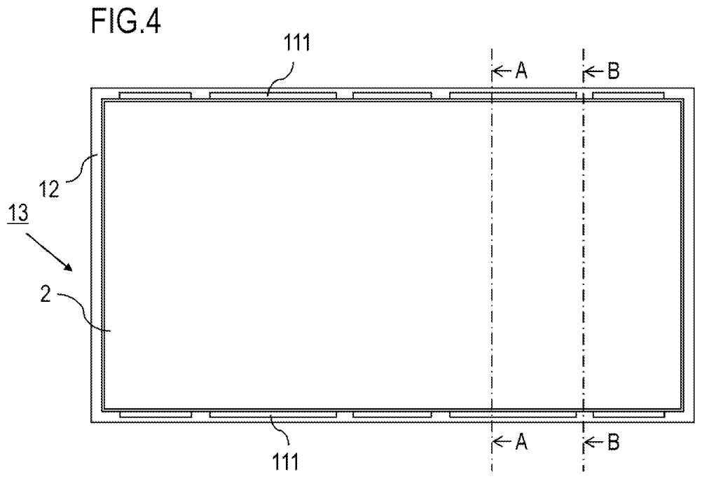

FIG. 4 is a front view of the display panel 2 and the panel holder 12 of the first embodiment. The first vent holes 111 communicating with the first space 21 extend along the upper and lower edges of the display module 13. Further, sections that hold the display panel 2 and are free of an opening (a first vent hole 111) are preferably arranged at various locations. In a similar manner, the second vent holes 112 communicating with the second space 22 extend along the upper and lower edges of the display module 13. The sections that hold the display panel 2 and are free of an opening (a second vent hole 112) are preferably arranged at various locations. Each of the first and second vent holes 111 and 112 is preferably shaped as a rectangular opening along the upper or lower edge section of the display module, but the first and second vent holes 111 and 112 may have any other shape. Further, the area of each opening may be changed depending on its position relative to the display panel 2. The configuration described above allows for the heat dissipation and cooling of the whole display module including the light sources and the display panel 2, which generate a larger amount of heat than a conventional configuration, through ventilation.

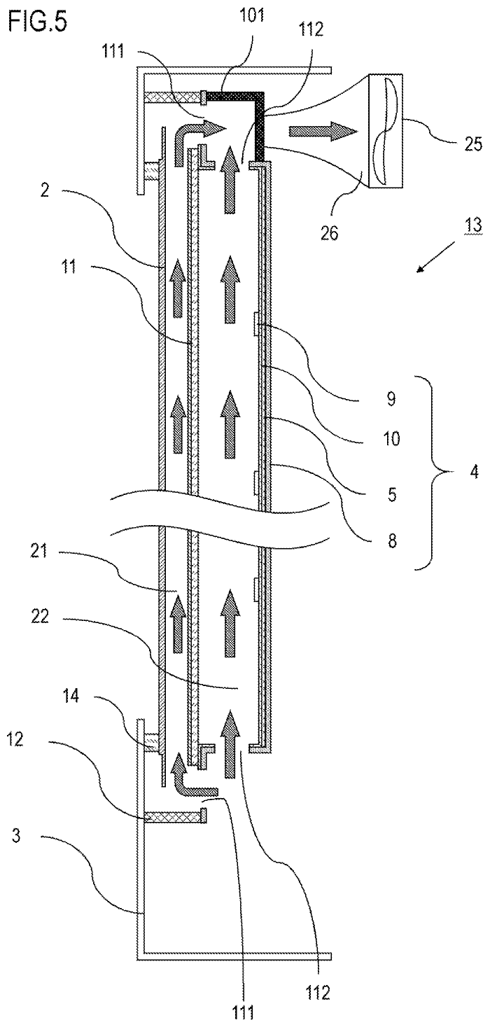

FIG. 5 is a cross-sectional view of the display apparatus 1 of a first modification of the first embodiment. As shown in FIG. 5, a ventilation member 101 may be provided along the upper edge of the display module 13 and connected to a fan 25 and a fan-coupling member 26, thereby discharging the air in the ventilation member 101.

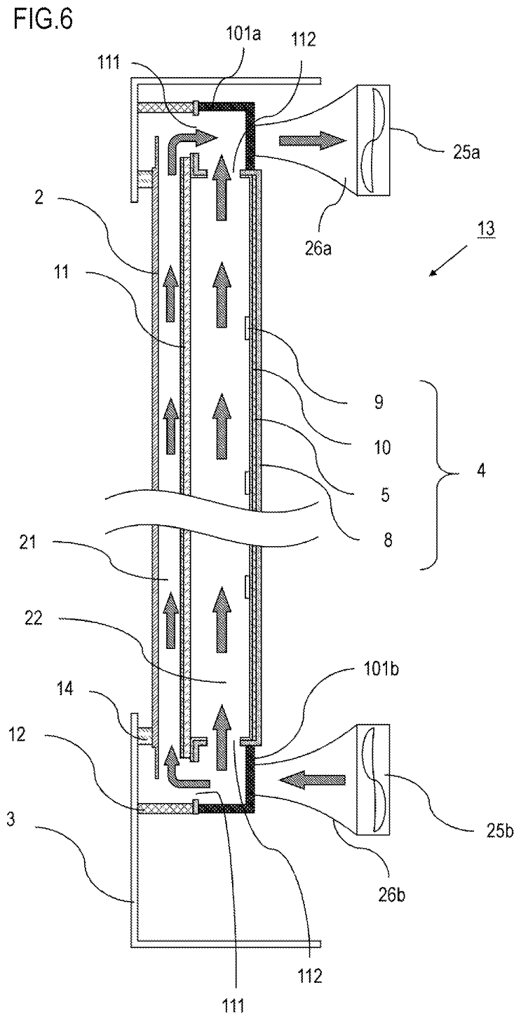

FIG. 6 is a cross-sectional view of a display apparatus 1 of a second modification of the first embodiment. As shown in FIG. 6, a ventilation member 101a may be provided along the upper edge of the display module 13, and a ventilation member 101b may be provided along the lower edge of the display module 13. That is, each ventilation members may be arranged so as to form a flow path that allows air to flow from one of the outside of the display apparatus 1 and a part of the first or second space 21 or 22 corresponding to at least one of the four outer edges of the display module 13 to the other. The air in the ventilation member 101a is thus discharged when a fan 25a and a fan-coupling member 26a are connected. Additionally, connecting a fan 25b and a fan-coupling member 26b allows air to be sent into the internal space of ventilation member 101a.

The configuration of the present embodiment thus forms a flow path that allows air to flow from one of the inside of the display module and the outside of the display apparatus to the other, thereby achieving the efficient heat dissipation and cooling of the whole display module. Additionally, the flow path by means of the ventilation member extending along the display module can ventilate the whole display module with a minimal number of fans. Further, the fan serving as the ventilation source is positioned on the back side of the display apparatus away from the display module, allowing the display apparatus to have a narrow frame.

### Second Embodiment

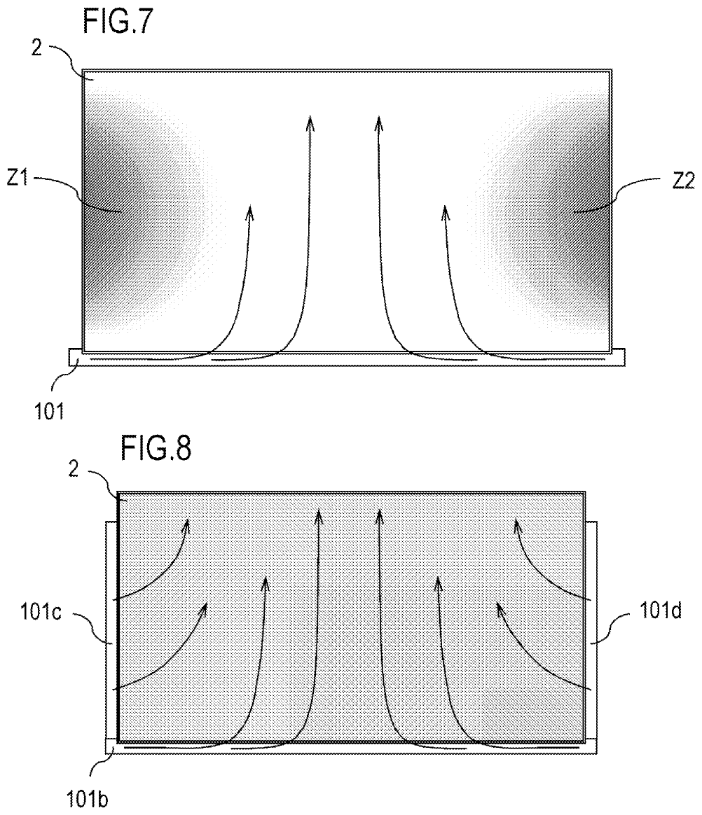

Referring to FIGS. 7 and 8, a display apparatus 1 of a second embodiment is now described. FIG. 7 is a diagram illustrating the surface temperature of the display panel 2 of the first embodiment. The first embodiment described above has a configuration in which a ventilation member 101 is provided along at least one of the lower and upper edges of the display module 13. However, in the first embodiment, as shown in FIG. 7, the volume of air flowing through each of left and right sections Z1 and Z2 of the display panel 2 is smaller than that in the central section. As such, when the temperatures of the right and left sections increase due to factors including the installation state and the image displayed, temperature non-uniformity can occur. The temperature non-uniformity affects the characteristics of the display panel 2 and the light sources, leading to color non-uniformity and brightness non-uniformity. FIG. 7 shows regions with high temperatures in the left and right sections Z1 and Z2 of the display panel 2, but the shapes of such regions are not necessarily balanced (symmetrical) as shown in FIG. 7. Temperature non-uniformity may occur in various shapes depending on factors including the installation state of the display apparatus 1 and the image displayed.

FIG. 8 is a diagram showing the display panel 2 and ventilation members 101b, 101c, and 101d of the second embodiment, and the surface temperature of the display panel 2. The parts shown in FIG. 8 that are common to the first embodiment are not described. In the second embodiment, in addition to the ventilation member 101b provided along the lower edge, ventilation members 101c and 101d are provided along the left and right edges, respectively, of the display panel 2. The ventilation members 101c and 101d are provided along the left edge and the right edge of the display panel 2 in a similar manner as the first embodiment. Fans 25 and fan-coupling members 26 (not shown in FIG. 8) are connected to the ventilation members 101c and 101d to send air to the internal spaces in the ventilation members 101c and 101d. In the second embodiment, the three ventilation members 101b, 101c, and 101d surrounding the display panel 2 ventilate the first space 21 behind the display panel 2, achieving the uniform heat dissipation and cooling of the entire surface of the display panel 2.

The length of each ventilation member is now described. Since the ventilation member 101b provided along the lower edge is the main ventilation member, the ventilation member 101b preferably extends over the entire width from the left end to the right end of the display panel 2. In contrast, since the ventilation members 101c and 101d on the left and right edges are provided to assist the main ventilation member 101b, these members do not have to extend over the entire length of the left or right edge from the upper end to the lower end. It is sufficient that the ventilation members 101c and 101d each extend partially between the lower end and the upper end of the display panel 2. The length and position of the ventilation members 101c and 101d are not limited to those shown in FIG. 8, and any length and position that limit temperature non-uniformity of the display panel 2 (reduce the in-plane temperature variations) may be selected according to the conditions such as the internal structure of the display apparatus 1.

The flow-path systems formed by the ventilation members are now described. The flow path formed by the ventilation member 101b provided along the lower edge, the flow path formed by the ventilation member 101c provided along the left edge, and the flow path formed by the ventilation member 101d provided along the right edge preferably form different, independent systems. That is, a fan 25 and a fan-coupling member 26 are preferably provided independently to send air to the internal space of each of the ventilation members 101b, 101c, and 101d. Forming the independent flow-path systems allows the air volume to be adjusted for each flow-path system, achieving uniform cooling effects in the plane of the display panel 2 (limiting temperature non-uniformity and reducing the in-plane temperature variations). The air volume may be adjusted by any of various methods, including controlling the value of current supplied to each fan 25, and providing an adjusting valve (on-off valve) in the middle of each flow path system. The ventilation members are not limited to the independent systems described above. For example, the air sent from a fan 25 may be branched (bifurcated) into the ventilation member 101b and the ventilation member 101c (or the ventilation member 101d) by a ventilation member (not shown).

The second embodiment has the ventilation members 101b, 101c, and 101d provided along the lower, left, and right edges of the display module 13 as described above, but a ventilation member 101a may also be provided along the upper edge. Ventilation members may be provided according to the internal structure of the display apparatus 1 or other conditions so as to avoid temperature non-uniformity of the display panel 2 (to reduce the in-plane temperature variations). The ventilation members 101b, 101c, and 101d of the second embodiment are all designed to take in ambient air, but the present invention is not limited to this configuration. For example, the ventilation member 101b may be used to take in ambient air, while the ventilation members 101c and 101d may be used to discharge air. Further, only the ventilation members 101c and 101d along the left and right edges may be provided.

As described above, the configuration of the second embodiment evenly ventilates the first space 21 and thus uniformly cools the display panel 2 as shown in FIG. 8. This reduces the in-plane temperature variations of the display panel 2 and limits color non-uniformity and brightness non-uniformity of the display panel 2.

### Third Embodiment

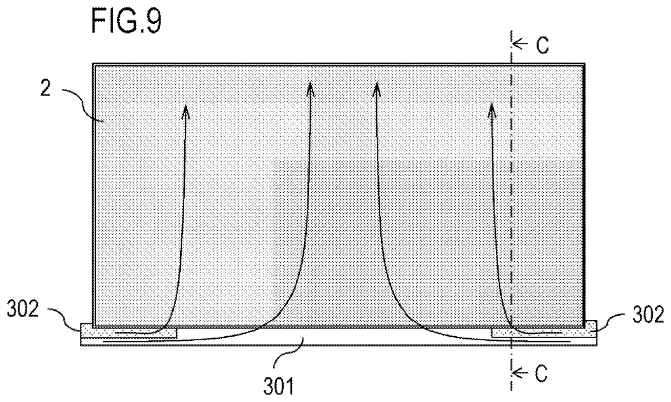

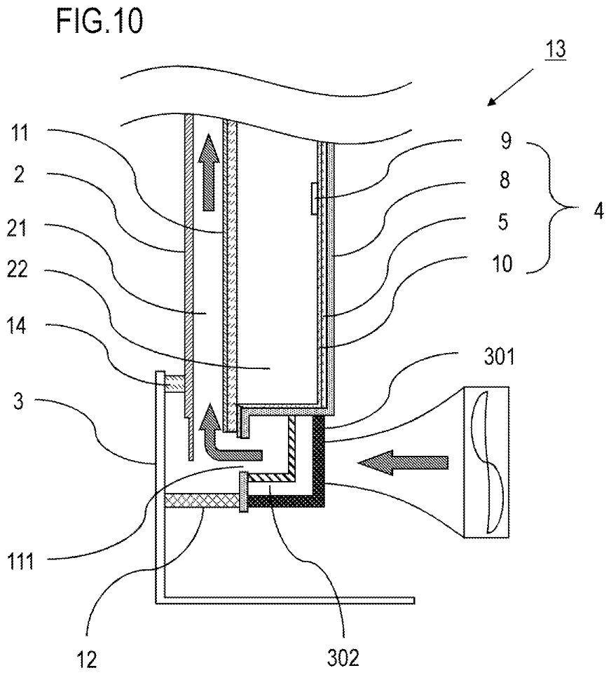

Referring to FIG. 9, a display apparatus 1 of a third embodiment is now described. FIG. 9 is a front view of a display panel 2 of the third embodiment. FIG. 10 is a cross-sectional view of the display apparatus 1 of the third embodiment taken along line C-C in FIG. 9. The present embodiment has a primary ventilation member 301, which is provided along the lower edge of the display module 13, and secondary ventilation members 302, which are provided in the primary ventilation member 301 and extend from the left and right ends of the primary ventilation member 301. The ends of the secondary ventilation members 302 closer to the center of the primary ventilation member 301 are closed. The primary ventilation member 301 is coupled to the secondary ventilation members 302 by screws, rivets, or the like. The primary ventilation member 301 and the secondary ventilation members 302 are preferably made of the same material, but may be made of different materials.

The length of each ventilation member is now described. The primary ventilation member 301 of the third embodiment extends along the lower edge over the entire width of the display panel 2 from the left end to the right end as viewed from the front. In contrast, the secondary ventilation members 302, which extend from the left and right ends of the primary ventilation member 301 to assist the primary ventilation member 301, do not extend from one end to the other of the display panel 2 and extend only partially. As such, the primary ventilation member 301 forms a flow path for the central section of the display panel 2, while the secondary ventilation members 302 form flow paths for the left and right sections of the display panel 2, thereby reducing the in-plane temperature variations of the display panel 2. The ranges of the secondary ventilation members 302 are not limited to those shown in FIG. 9 and may be set according to the internal structure of the display apparatus 1 or other conditions so as to avoid temperature non-uniformity of the display panel 2 (to reduce the in-plane temperature variations). As long as the secondary ventilation members 302 communicate with the first vent hole 111 and the first space 21, the secondary ventilation members 302 may be positioned outside the primary ventilation member 301. A plurality of ventilation members may be provided at least one of the left, right, and upper edges, in addition to the lower edge as shown in FIG. 9. When fans 25 and fan-coupling members 26 are connected to the secondary ventilation members 302, the secondary ventilation members 302 do not have to extend from the left and right ends of the display panel 2. Further, air may be sent to the primary ventilation member 301 from a fan 25 provided at one side of the display panel 2, and air may be sent to each secondary ventilation member 302 from a fan 25 provided behind the display panel 2. This configuration allows for the adjustment of the volume of air blown into the primary ventilation member 301 and the volume of the air blown into the secondary ventilation members 302.

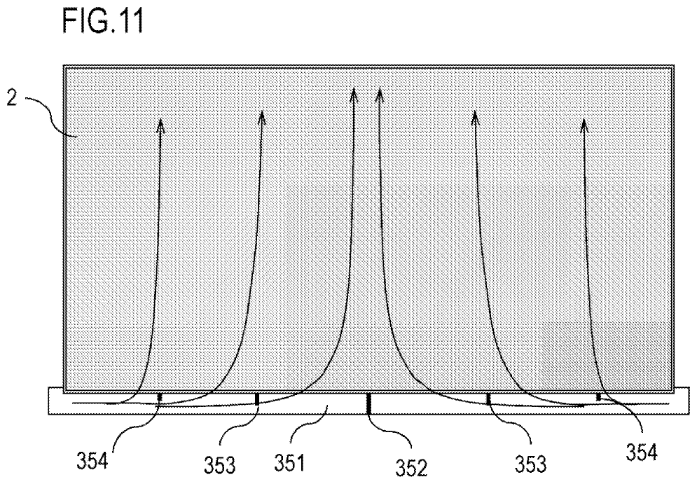

FIG. 11 is a diagram showing a display apparatus 1 of a first modification of the third embodiment. The display apparatus 1 shown in FIG. 11 includes a display panel 2 and a ventilation member 351. The ventilation member 351 extends along the lower edge of the display module 13 over the entire width of the display panel 2 from the left end to the right end as viewed from the front. A plurality of partitions 352 to 354 is provided in the ventilation member 351. The partitions adjust the volume of air flowing through the flow path in the ventilation member 351 by partially reducing the size of the flow path. The positions of the partitions 352 to 354 can be freely set. Further, the lengths of the partitions 352 to 354 may be uniform or different. Preferably, a partition closer to the center is longer as shown in FIG. 11. That is, a partition in the central section creates a smaller cross-sectional area of the flow path than a partition in an end section. As a result, when the ventilation member 351 forms flow paths extending from the opposite ends, the air blown into each flow path hits the partitions 354, 353, and 352 in this order, thus evenly flowing into the first space 21.

In the example of FIG. 11, the partition 352 completely separates the flow paths in the ventilation member 351, but the length of the partition 352 may be adjusted to form one flow path in the ventilation member 351. Further, the partitions 352 to 354 are preferably made of the same material as the ventilation member 351, but other material may also be used. Additionally, the number of the partitions may be freely set. As shown in FIG. 11, the partitions 353 and 354 are at positions closer to the display panel 2 (at the upper side), but may be provided at positions farther from the display panel 2 (at the lower side).

As described above, the configuration of the third embodiment evenly ventilates the first space 21 and therefore uniformly cools the display panel 2. This reduces the in-plane temperature variations and limits color non-uniformity and brightness non-uniformity.

### Fourth Embodiment

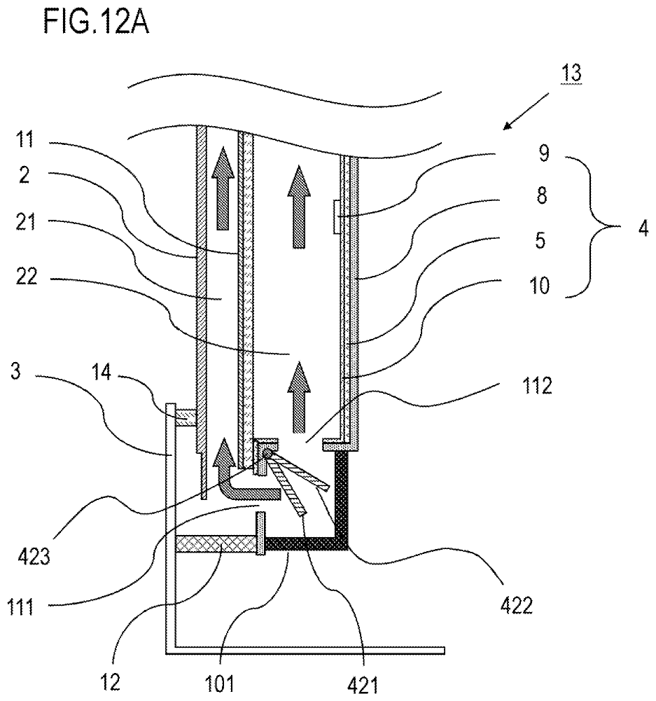

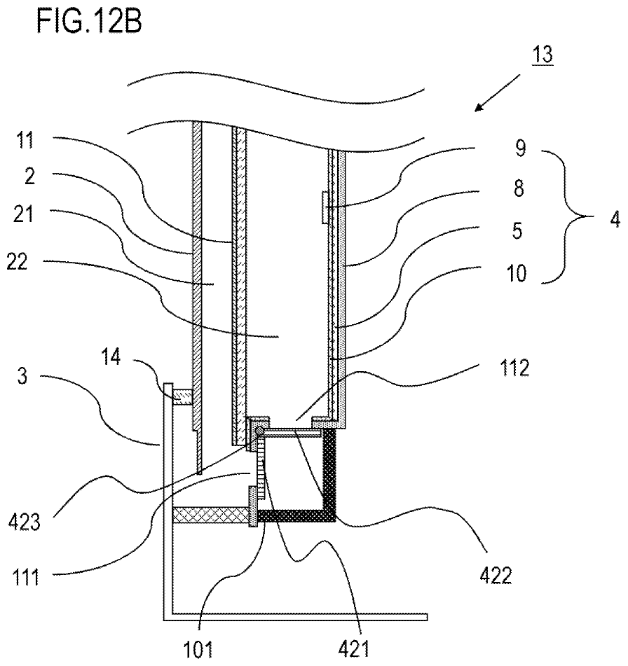

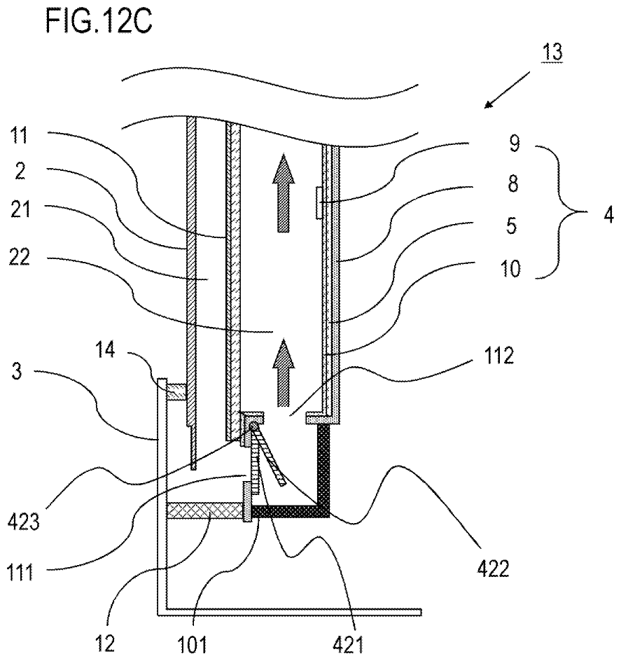

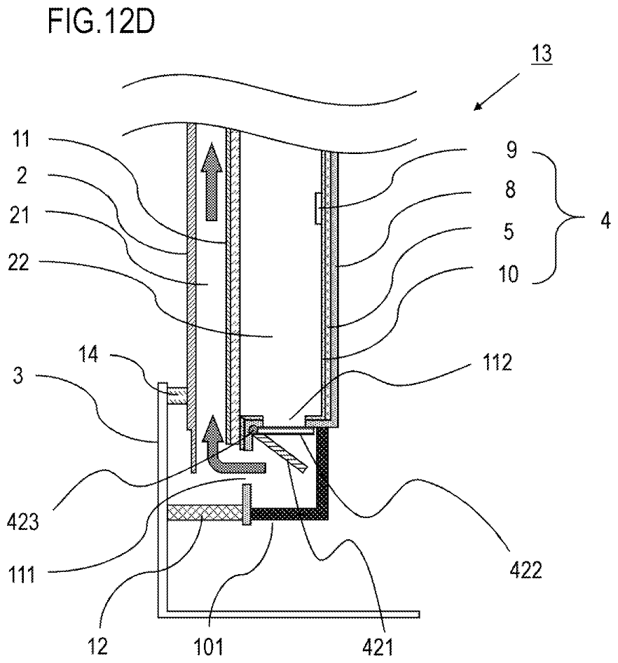

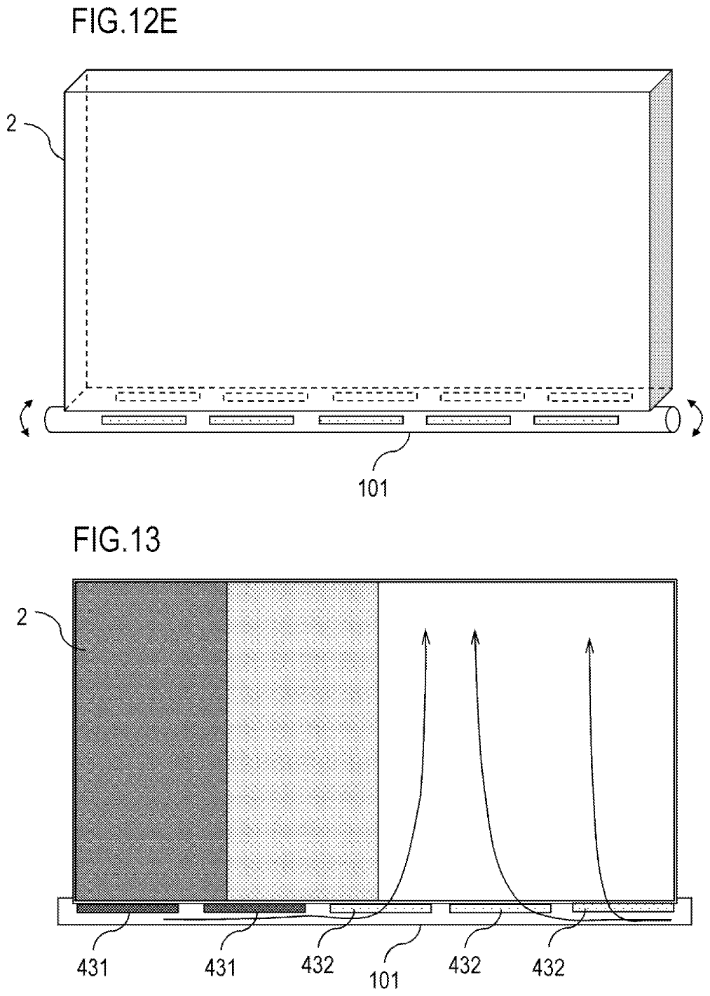

Referring to FIGS. 12A to 14, a display apparatus 1 of a fourth embodiment is now described. The display apparatus 1 of the fourth embodiment includes valves (on-off valves) that allow the first and second spaces 21 and 22 to have or not to have a flow path. This configuration may cool the display panel 2 by forming a flow path only in the first space 21, or may cool the backlight 4 and the light sources 9 by forming a flow path only in the second space 22, for example. This achieves effective cooling according to the heat generation of each component. Further, when the light sources 9 and the display panel 2 do not generate heat, the valves may be controlled so as not to form a flow path in either of the first and second spaces 21 and 22. When both the light sources 9 and the display panel 2 generate heat, flow paths may be formed in both spaces.

FIGS. 12A to 12D are cross-sectional views of the display apparatus 1 of the fourth embodiment. FIG. 12A is a diagram showing a state in which both the first and second valves 421 and 422 are open. FIG. 12B is a diagram showing a state in which both the first and second valves 421 and 422 are closed. FIG. 12C is a diagram showing a state in which the first valve 421 is closed and the second valve 422 is opened. FIG. 12D is a diagram showing a state in which the first valve 421 is opened and the second valve 422 is closed. Here, the term “opened” refers to a state in which the first valve 421 does not close the first vent hole 111 and a state in which the second valve 422 does not close the second vent hole 112. The term “closed” refers to a state in which the first valve 421 closes the first vent hole 111 and a state in which the second valve 422 closes the second vent hole 112.

The first and second valves 421 and 422 may be provided in various configurations. For example, multiple valves may be provided separately for the respective vent holes, or valves may be integrally connected. Further, the case 8 includes a rotational portion 423, which couples the first and second valves 421 and 422 to each other and is able to rotate these valves independently. The rotational portion 423 may be a hinge-shaped member to which an electric signal is sent. When receiving an electric signal, the rotational portion 423 rotates the first and second valves 421 and 422 serving as electromagnetic valves such as solenoids. The first and second valves 421 and 422 may be made of any material. The rotational portion 423 may include a magnet portion that assists the rotational mechanism.

The configuration described above can effectively cool the display panel 2 or the light sources 9 according to the display image and the brightness. FIG. 12A is a diagram showing an example in which both the display panel 2 and the light sources 9 should be cooled. The first and second valves 421 and 422 are both opened, forming flow paths in the first and second spaces 21 and 22. FIG. 12B is a diagram showing an example in which both the display panel 2 and the light sources 9 generate small amounts of heat (neither of them requires cooling). The first and second valves 421 and 422 are both closed, so that neither of the first and second spaces 21 and 22 has a flow path. Closing the first and second valves 421 and 422 advantageously limit light leakage and dust as will be described below. FIG. 12C is a diagram showing an example in which the light sources 9 should be effectively cooled. By closing the first valve 421 and opening the second valve 422, a flow path is formed only in the second space 22. FIG. 12D shows an example in which the display panel 2 should be effectively cooled. By opening the first valve 421 and closing the second valve 422, a flow path is formed only in the first space 21. Controlling the valves according to the display image and the brightness as described above can effectively cool different parts of the display apparatus 1. This limits the degradation of the image quality, which would otherwise occur due to color non-uniformity or brightness non-uniformity, for example. As shown in FIG. 12E, a cylindrical ventilation member 101 may also be used. The opening and closing of the first and second vent holes 111 and 112 may be controlled by rotating this ventilation member 101.

Referring to FIG. 13, the open and closed states of the vent holes of the present embodiment as viewed from the front are now described. FIG. 13 is a front view of the display panel 2 and the ventilation member 101 of the fourth embodiment. In the example shown in FIG. 13, the left side in the plane of the display panel 2 has a low brightness and the right side has a high brightness. Additionally, in the example shown in FIG. 13, of the first vent holes 111, the two vent holes on the left side of the ventilation member 101 as viewed from the front are closed sections 431, and the three vent holes at the center and on the right side are open sections 432. That is, a plurality of vent holes is provided for a part of the first space 21 corresponding to at least one of the four outer edges of the display panel 2. The opening and closing are controlled for each of the vent holes. The opening and closing of each vent hole can be controlled according to the brightness or the display image, by setting separate valves for the respective vent holes as described above. For example, the left and right sides may differ from each other in brightness when the local dimming control is performed. The local dimming control is a technique for increasing the contrast of the display image by individually controlling the light emission intensity of each of multiple light sources to partially change the brightness of the backlight device. The local dimming control analyzes the brightness gradation value of the image signal for each of divided regions forming an image region, and controls the light emission intensity of the light source corresponding to the divided region based on the result of analysis. This creates temperature variations in the planes of the display panel 2 and the backlight 4 according to the display image and the brightness. The fourth embodiment adjusts the balance of air volumes by controlling the opening and closing of each vent hole so as to increase the air volume in a section with a high temperature.

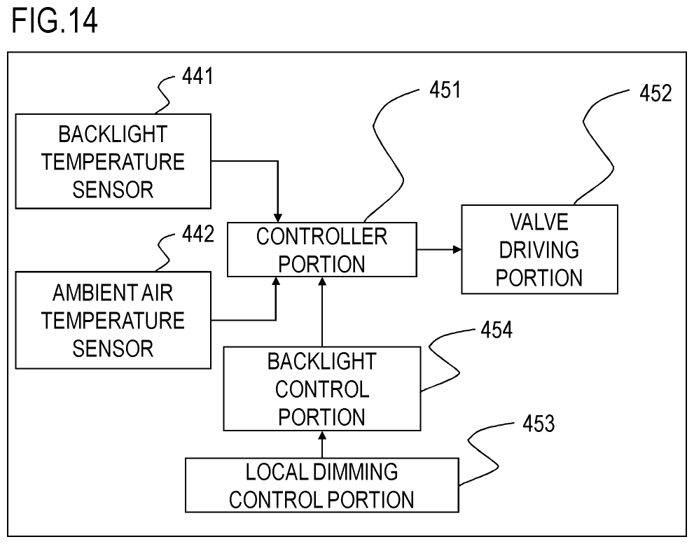

FIG. 14 is a functional block diagram illustrating opening and closing control of a valve. The display apparatus 1 controls the opening and closing of a valve based on the temperature of the backlight 4 and the temperature of ambient air.

The controller portion 451 obtains the temperature of the backlight 4 with backlight-temperature sensors 441 provided on the light-source board. Preferably, a plurality of backlight-temperature sensors 441 is arranged in the plane in order to accurately obtain the temperatures in the plane. Further, the controller portion 451 obtains the temperature of ambient air with an ambient-air-temperature sensor 442 provided at a position away from the heating elements. The temperature of the display panel 2 can be calculated from the temperature of the backlight 4, but a temperature sensor may be provided near the display panel 2 to obtain the temperature of the display panel 2, in addition to the temperature sensors described above. The controller portion 451 also obtains a control signal for the backlight from a backlight-control portion 454, which will be described below.

Then, based on the temperature of the backlight 4, the temperature of ambient air, and the control signal of the backlight 4 that are obtained, the controller portion 451 determines whether to form a flow path in the first space 21 or the second space 22. For example, a flow path may be formed in the first space 21 when the temperature of ambient air is greater than or equal to a threshold value T1, and a flow path may not be formed in the first space 21 when the temperature of ambient air is lower than the threshold value T1. Likewise, a flow path may be formed in the second space 22 when the temperature of the backlight 4 is greater than or equal to a threshold value T2, and a flow path may not be formed in the second space 22 when the temperature of the backlight 4 is lower than the threshold value T2. As described with reference to FIG. 13, the valve provided for each vent hole may be individually controlled to open and close. This is particularly suitable for the local dimming control.

A valve-driving portion 452 drives each valve according to the determination result of the controller portion 451. A local dimming control portion 453 controls the light emission intensity value of each light source based on the brightness value of the image signal. The backlight-control portion controls the brightness of the light source based on the light emission intensity value of the light source, and transmits a control signal to the controller portion 451.

The fourth embodiment described above uses first and second valves and a rotational portion, but any configuration may be used as long as the opening and closing of each vent hole can be controlled. For example, one L-shaped valve may be used to control the opening and closing of each vent hole. Alternatively, a rotational portion and a filter attached to the rotational portion (a filter for closing the first or second vent hole 111 or 112) may be controlled to open and close each vent hole.

As described above, each vent hole is opened, closed, and controlled to effectively cool the heating elements, such as the display panel and the light sources, thereby reducing the temperature variations in the planes. This limits color non-uniformity and brightness non-uniformity in terms of the image quality.

### Fifth Embodiment

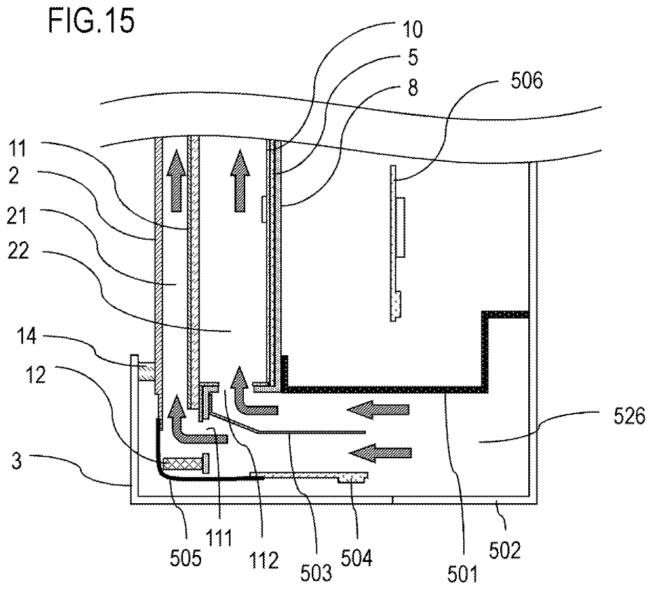

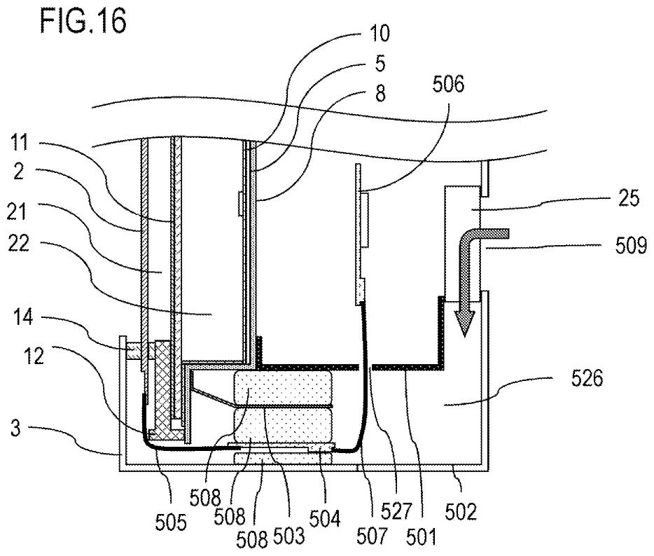

Referring to FIGS. 15 and 16, a display apparatus 1 of a fifth embodiment is now described. FIG. 15 is a cross-sectional view of the display apparatus 1 of the fifth embodiment, taken along line A-A in FIG. 2. FIG. 16 is a cross-sectional view of the display apparatus 1 of the fifth embodiment, taken along line B-B in FIG. 2.

An exterior member 502 covers the back surface and the side surfaces of the display apparatus 1, and forms an exterior member (enclosure) that covers the display apparatus 1 together with the bezel 3.

A partition member 501 is arranged in the exterior member 502 and faces the lower sides of the bezel 3 and the exterior member 502. The partition member 501 extends from a position near the lower side of the case 8 toward the back side and is in contact with the back side of the exterior member 502. The partition member 501 is also in contact with the inner surfaces of the sides of the bezel 3 and the exterior member 502. In the present embodiment, the partition member 501 may be formed of a sheet metal or a resin molding material and fixed to the case 8 by using screws, rivets, or double-sided tape, for example. A cushion member may be arranged at each of the positions where the partition member 501 is in contact with the bezel 3, the case 8, and the exterior member 502 to improve airtightness. In the fifth embodiment, the partition member 501, the bezel 3, and the exterior member 502 define a ventilation passage 526 extending from the first and second vent holes 111 and 112 to a fan 25.

The fan 25 is a sirocco fan provided in the exterior member 502 at the back side. The fan 25 takes in air through an opening 509 in the back side of the exterior member 502 and blows it to the ventilation passage 526 (to the inside).

A light-shielding member 503 is arranged between the first and second vent holes 111 and 112 and extends from the case 8 toward the back side of the display apparatus 1. The light-shielding member 503 is also in contact with the inner surfaces of the sides the bezel 3 and the exterior member 502. The light-shielding member 503 may be made of a material that does not transmit light, such as a sheet metal or a resin sheet. The light-shielding member 503 reduces the possibility that the light coming through the second vent hole 112 travels through the first vent hole 111 and enters the display panel 2.

A panel-driving board 504 is a circuit board connected to the display panel 2 via a flexible printed circuit (FPC) 505 to drive the display panel 2. The panel-driving board 504 is opposed to and extends along the lower side of the display panel 2. The FPC 505 extends from the display panel 2 and then bends to extend along the lower side of the bezel 3 to the panel-driving board 504.

A timing controller board 506 is a circuit board (electric board) that operates the panel-driving board 504 via a flexible flat cable (FFC) 507 (cable), and is arranged inside the exterior member 502 and at the inner side of the partition member 501. The FFC 507 extends through an FFC-insertion hole 527 (insertion hole) formed in the partition member 501.

Spacers 508 are arranged between components including the bezel 3, the case 8, the partition member 501, the light-shielding member 503, and the panel-driving board 504, and hold the respective components with predetermined spacing. The spacers 508 are arranged discontinuously along the panel-driving board 504. The discontinuous arrangement of the spacers 508 form discontinuous ventilation passages (flow paths) in the space defined by the case 8, the partition member 501, and the light-shielding member 503, and in the space between the light-shielding member 503 and the panel-driving board 504. Accordingly, even when the panel-driving board 504 and the FPC 505 are present, air can flow from the first and second vent holes 111 and 112 to the fan 25.

In the fifth embodiment described above, the ventilation passage 526 and the panel-driving board 504 are arranged along the lower side of the display apparatus 1. However, the ventilation passage 526 and the panel-driving board 504 may be arranged along the upper, left, or right side of the display apparatus 1. When the ventilation passage 526 and the panel-driving board 504 are arranged along the upper, left, or right side of the display apparatus 1, the ventilation passage 526 is still provided at the inner side of the panel-driving board 504 as in the fifth embodiment.

Additionally, the partition member 501 may be arranged such that the partition member 501 is farther from the exterior member 502 at locations closer to the fan 25. This increases the cross-sectional area of the flow path of the ventilation passage 526, reducing the ventilation resistance.

To control the flow rate of the air to the first and second vent holes 111 and 112, a baffle plate or a protrusion may be provided in the ventilation passage 526. In particular, since the flow velocity tends to increase in the vicinity of the discharge port of the fan 25, it is advantageous to provide a baffle plate at a position that is opposed to (corresponds to) the discharge port of the fan 25. For example, the FFC 507 may be arranged to face the discharge port of the fan 25 to function as a baffle plate.

The configuration of the fifth embodiment allows the dimension of the ventilation passage 526, which extends from the fan 25 to the first and second vent holes 111 and 112, to be reduced in the frame direction. Additionally, the dimension in the direction perpendicular to the drawing plane can be increased (i.e., the flow path length between the fan and the vent holes can be increased) to increase the cross-sectional area of the flow path of the ventilation passage 526, thereby reducing the ventilation resistance. As a result, sufficient ventilation is achieved even with a low-noise, compact fan of low rotation speed. Additionally, controlling the flow velocity using a baffle plate limits temperature non-uniformity of the display panel 2.

### Sixth Embodiment

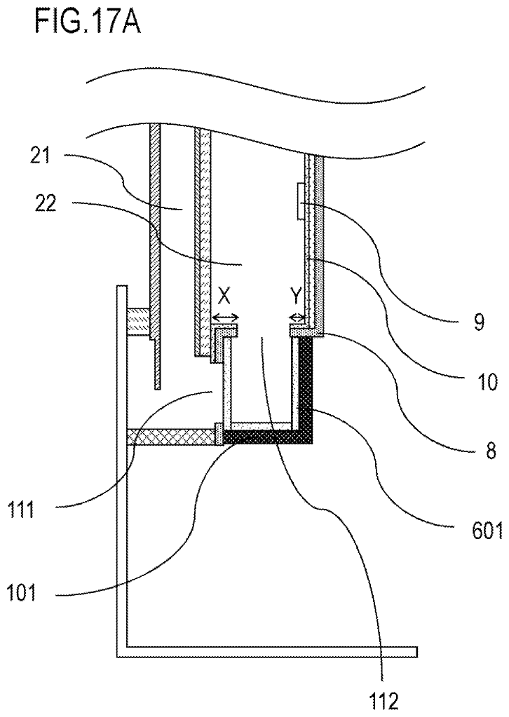

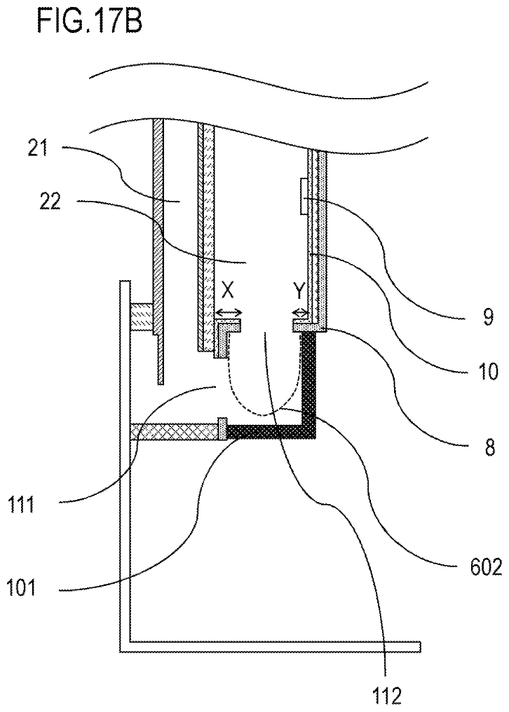

Referring to FIGS. 17A and 17B, a display apparatus 1 of a sixth embodiment is now described. With the display apparatus 1 of the first embodiment, the light emitted by the light source 9 may leak through the second vent hole 112, lowering the brightness in the periphery section of the backlight 4. The reduced brightness in the backlight periphery section reduces the brightness of the image output by the display panel 2, degrading the image quality. If the output of the backlight 4 is increased to solve this problem, the temperature of the backlight 4 would increase. For this reason, the display apparatus 1 of the sixth embodiment has a reflective member in the ventilation member 101 to limit a reduction in the brightness caused by leakage through the second vent hole 112.

FIG. 17A is a cross-sectional view of the display apparatus 1 of the sixth embodiment. The reflective member 601 is arranged in the ventilation member 101. The reflective member 601 reflects the light of the backlight 4 leaking through the second vent hole 112, thereby returning the light to the second space 22. This limits a reduction in the brightness. If the first space 21 do not require ventilation, the reflective member 601 may close the first vent hole 111. Further, the reflective member 601 may be provided on all the inner surfaces of the hollow structure serving as a ventilation portion. That is, the reflective member 601 may be provided not only on the inner sides of the ventilation member 101 but also on the inner sides of the section of the case 8 forming a hollow structure.

Even when the light reflected by the reflective member 601 returns to the second space, the brightness in the periphery section of the backlight 4 may still be reduced as compared with a configuration in which the second vent hole 112 is not provided. This can be caused because the optical path through which the light reflected by the reflective member 601 travels to return to the periphery section of the backlight 4 is long, or leaked light fails to return to the light source where it originates and reaches another light source in the central section of the backlight 4.

As such, instead of the reflective member 601, a curved (arc-shaped) reflective member 602 may be used as shown in FIG. 17B. When the second vent hole 112 is provided, the brightness can be particularly lowered in the periphery section of the backlight 4. This is primarily caused by the leakage of light emitted from outermost light sources, which are light sources 9 at the outermost positions. Since the intensity of a light beam is inversely proportional to the square of the distance, the curved reflective member 602 is used to return a light beam to the second space 22 in a shorter optical path. To return a light beam to the periphery section in the shortest path, the curved surface of the reflective member 602 is preferably aligned with a circle about the outermost light source. The reflective member 602 forming a curved surface functions more effectively when the regular reflectance, which is a characteristics of the reflective member 602 relating to the equality between the incident angle and the reflection angle, is higher. Alternatively, regardless of whether the reflective member 602 forms a curved surface, the surface of the reflective member 601 or the reflective member 602 may be treated such that light beams are directed to a desired position.

Further, the position of the opening of the second vent hole 112 is preferably set according to the directional characteristic of the light source 9. For example, when the directional characteristic of the light source 9 is of a Lambertian distribution, the luminous intensity is higher in a direction closer to the output direction of the light source 9 (directly above). As such, in order for light beams with a higher luminous intensity to reach the periphery section of the backlight 4 in the shortest path without leaking, the position of the second vent hole 112 may be adjusted accordingly. For example, the relationship between the distance (distance X) from the front side of the second space 22 to the second vent hole 112 and the distance (distance Y) from the rear side of the second space to the second vent hole 112 may be X>Y. Further, Y may be 0. The reflective member 601 and the reflective sheet 10 may be formed integrally as a single member. The reflective member 601 and the reflective sheet 10 may be identical members or different members. For example, the reflective sheet 10 may be a foamed PET sheet, and the reflective member 601 may be a mirror with specular reflection.

The reflective member 601 preferably has a diffuse reflectance of greater than or equal to 80%. The reflective member 601 may also be omitted. In this case, the inner surface of the ventilation member 101 should have a high reflectance. For example, when the ventilation member 101 is made of an aluminum material, the reflectance may be increased by performing aluminum electrolytic polishing, for example. Alternatively, the whole ventilation member 101 may be made of a resin having a high reflectance.

The configuration described above can limit a reduction in the brightness in the periphery section of the backlight 4 and a reduction in the image quality, even when the second vent hole 112 communicating with the second space 22 is provided to dissipate heat.

### Seventh Embodiment

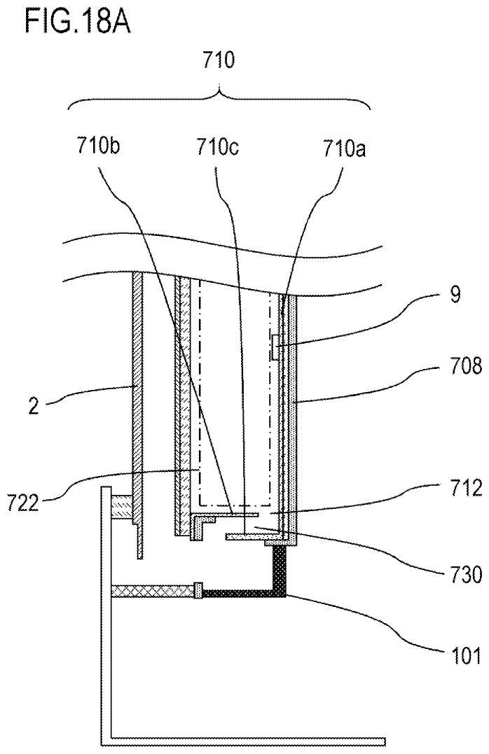

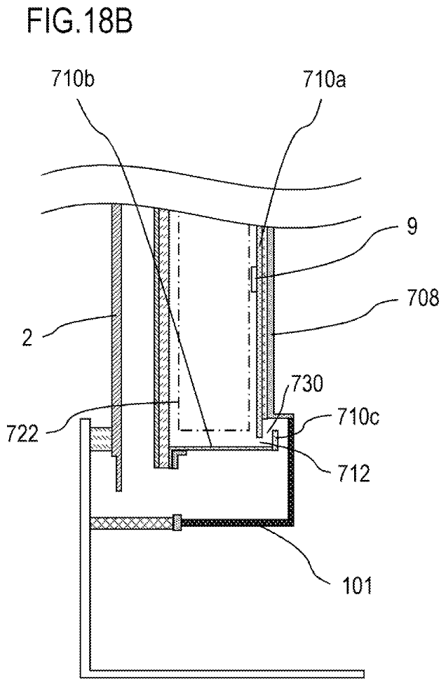

Referring to FIGS. 18A and 18B, a display apparatus 1 of a seventh embodiment is now described. The sixth embodiment is an example in which a reflective member surrounds the internal space of the ventilation member 101 so that the light of the backlight 4 leaking through the second vent hole 112 is returned to the second space 22. The seventh embodiment has the same objective of returning the leaked light of the backlight 4 to the second space, but achieves this objective with a different configuration of the backlight 4 of the display apparatus 1. The following descriptions focus on the differences from the first embodiment.

FIG. 18A is a cross-sectional view of the display apparatus 1 of the seventh embodiment. The seventh embodiment has a case 708 that includes, instead of the reflective sheet 10 of the first embodiment, a bottom reflective sheet 710a, a side reflective sheet 710b, and a periphery reflective sheet 710c. The bottom reflective sheet 710a, the side reflective sheet 710b, and the periphery reflective sheet 710c may be referred to as reflective sheets 710 when they are not distinguished from one another. A second vent hole 712 and a second space 722 correspond to the second vent hole 112 and the second space 22, respectively, of the first embodiment. Further, in the seventh embodiment, the side reflective sheet 710b, the periphery reflective sheet 710c, and other parts form a gap flow path 730, which will be described below.

The bottom reflective sheet 710a covers the side of the second space 722 corresponding to the light sources 9. The side reflective sheet 710b covers a part of a side of the second space 722 (the lower side as viewed in FIG. 18A). The end of the side reflective sheet 710b closer to the bottom reflective sheet 710a is spaced apart from the bottom reflective sheet 710a, thereby forming the second vent hole 712. The second vent hole 712 may also be considered as the part of a side of the second space 722 that is not covered by the side reflective sheet 710b. The periphery reflective sheet 710c is in contact with the bottom reflective sheet 710a and substantially parallel to the side reflective sheet 710b. The periphery reflective sheet 710c is at the outer side of the side reflective sheet 710b and spaced apart from the side reflective sheet 710b. The periphery reflective sheet 710c may be considered as overlapping with the side reflective sheet 710b in the plane direction. The space between the periphery reflective sheet 710c and the side reflective sheet 710b forms the gap flow path 730 that provides communication between the internal space of the ventilation member 101 and the second vent hole 712.

Part of the light emitted by the light source 9 enters the gap flow path 730 via the second vent hole 712. However, since the gap flow path 730 is surrounded by the reflective sheets 710, the entering light is repeatedly reflected within the gap flow path 730, and part of the light returns to the second space 722. This reduces the loss of light in the second space 722, limiting a reduction in the brightness particularly in the backlight periphery section, where the second vent hole 712 is present.

FIG. 18B is a cross-sectional view of a display apparatus 1 of a modification of the seventh embodiment. As shown in FIG. 18B, the periphery reflective sheet 710c may be in contact with the side reflective sheet 710b and parallel to the bottom reflective sheet 710a. The periphery reflective sheet 710c may be at the outer side of the bottom reflective sheet 710a and spaced apart from the bottom reflective sheet 710a. The gap flow path 730 is thus provided in the back side of the display apparatus 1, allowing the frame to be narrow.

The seventh embodiment uses two reflective sheets that are parallel to and spaced apart from each other to form a gap flow path, which returns leaked light from the backlight 4 to the second space 22. However, only one reflective sheet may be used. For example, a film reflective sheet (film reflective member) may be positioned between the second vent hole 112 and the second space 22 in the first embodiment and partially fixed to the reflective sheet 10. When air is sent toward the second space 22, a part the film reflective sheet (the section that is not fixed to the reflective sheet 10) floats into the second space 22, so that the film reflective sheet does not block the flow path, enabling the ventilation of the second space 22.

In the seventh embodiment, the periphery reflective sheet 710c is located at the outer side of the side reflective sheet 710b and spaced apart from the side reflective sheet 710b. Alternatively, the periphery reflective sheet 710c may be located at the inner side of the side reflective sheet 710b and spaced apart from the side reflective sheet 710b. The reflective sheets 710 may have any reflectance and include any material. The bottom reflective sheet 710a and the periphery reflective sheet 710c may form a single member. The configuration of the seventh embodiment and the configuration of the sixth embodiment may be combined. The loss of light in the second space 722 is thus reduced.

### Eighth Embodiment

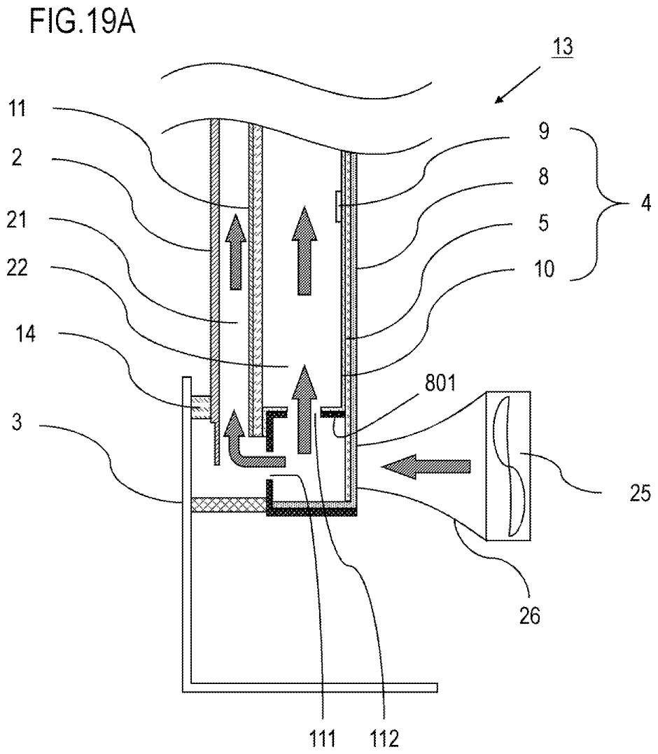

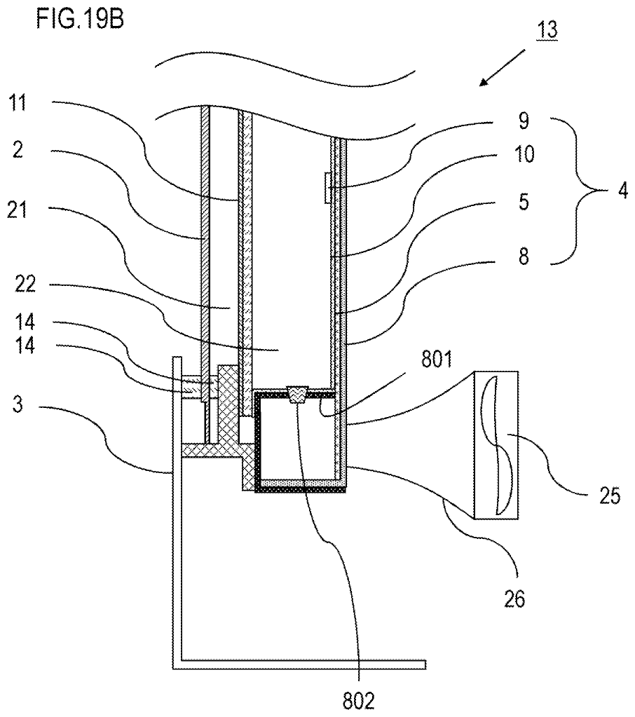

Referring to FIGS. 19A and 19B, a display apparatus 1 of an eighth embodiment is now described. This embodiment is an example in which the size of the light-source board is larger than the size of the effective display area of the display panel, and the light-source board serves as one component of a hollow structure. The differences from the first embodiment are described below in detail, and the same features as the first embodiment are not described.

FIG. 19A is a cross-sectional view of a display apparatus 1 of the eighth embodiment, taken along line A-A in FIG. 2. FIG. 19B is a cross-sectional view of the display apparatus 1 of the eighth embodiment, taken along line B-B in FIG. 2.

The eighth embodiment is configured in consideration of a situation where the light-source board forming the backlight 4 accommodates a greater number of light sources 9 to increase the brightness for HDR imaging, and a situation where a light-source driving circuit or other components are mounted on the side of the light-source board 5 opposite to the mount surface for the light sources 9. In such situations, the size of the light-source board 5 may be set to be larger than the effective display area of the display panel 2, and components such as light sources 9 and a light-source driving circuit are mounted on the light-source board 5. However, when the light-source board 5 is larger in size than the effective display area of the display panel 2, display non-uniformity can occur. This is because when the reflective sheet 10 is fixed to a side of the case 8 (the surface under the second space 22 as viewed in FIG. 19A), the distance is increased between the light sources 9 at the end (in the lowest section) and the section of the reflective sheet 10 on the side of the case 8, reducing the brightness in the outer edge section of the display module 13. Further, when the light-source board 5 is larger in size than the effective display area of the display panel 2, placing the ventilation member 101 of the first embodiment outside the case 8 would increase the size of the frame of the display module 13.

The eighth embodiment includes, in addition to the light-source board 5 and the case 8, a second case 801 (sub backlight case) for fixing a side of the reflective sheet 10. The light-source board 5 (the section extending outward of the effective display area of the display panel 2), the case 8, and the second case 801 (flow-path forming member) form a hollow structure (a part of the flow path). The second case 801 preferably has an L-shaped or U-shaped cross-section. With either shape, the second case 801 has openings communicating with the first and second vent holes 111 and 112. The reflective sheet 10 is fixed to the second case 801 by a fixing member 802 shown in FIG. 19B.

A side of the second case 801 (the side under the second space 22 as viewed in FIG. 19A) has a second vent hole 112, which extends through the second case 801 and the reflective sheet 10 and communicates with the second space 22. In the eighth embodiment, the second vent hole 112 is provided in the A-A cross-section in FIG. 2, and the fixing member 802 is provided in the B-B cross-section in FIG. 2. However, the sizes and positions may be adjusted such the second vent hole 112 and the fixing member 802 are both located in the same cross-section.

The eighth embodiment thus forms a flow path within the display module 13 for ventilation, thereby achieving the heat dissipation and cooling of the display module. In the eighth embodiment, the flow path within the hollow structure along the display module 13 can ventilate the whole display module with a minimal number of fans. Further, even when the light-source board 5 is larger in size than the effective display area of the display panel 2, the eighth embodiment, which uses the light-source board 5 as a component of the hollow structure, can have a narrow frame.

The second case 801 may fix the light-source board 5 and the case 8 in a section that is in contact with the light-source board 5 and located between the second vent hole 112 and the light-source board 5. This eliminates the need for a fixing member for fixing the second case 801 to the case 8. In another example, the second case 801 is fixed to the case 8 by a fixing member, and the second case 801 includes a reflective sheet 10. In this example, the section of the second case 801 to which the fixing member is attached may be formed as a recess. This limits warping of the reflective sheet 10 even if the fixing member causes the second case 801 to warp. In the example of FIGS. 19A and 19B, the second case 801 is in contact with the light-source board 5, but an electric circuit member (e.g., a component of the power supply circuit member) that tends to generate heat may be placed between the second case 801 and the light-source board 5 (in the flow path). This effectively cools the component that tends to generate heat.

### Ninth Embodiment

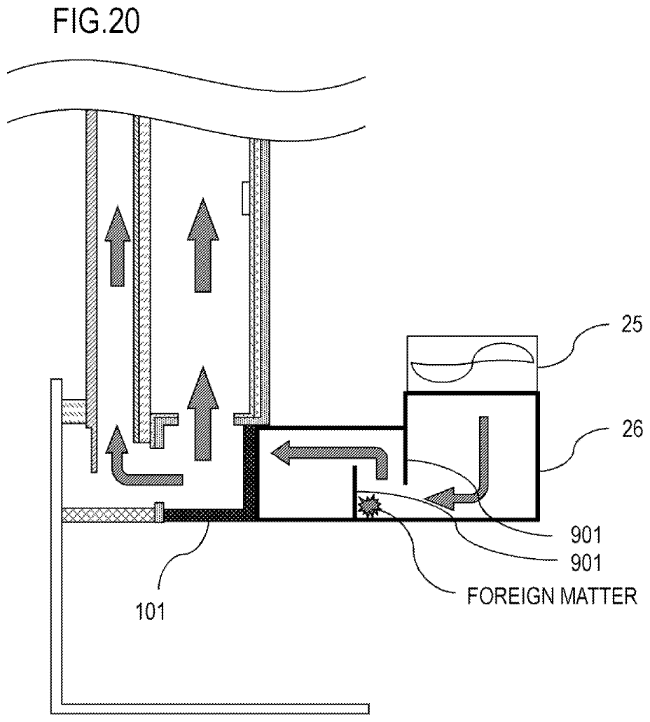

Referring to FIG. 20, a display apparatus 1 of a ninth embodiment is now described. If foreign matter such as dust enters the display module 13 and adheres to the display panel 2 or the optical-sheet group 11, light may be locally blocked, degrading the image quality. To solve this problem, the display apparatus 1 of the ninth embodiment has a dust-prevention structure provided in the intake and discharge section to protect the display module 13 from dust when ventilating.

FIG. 20 is a cross-sectional view of the display apparatus 1 of the ninth embodiment. The display apparatus 1 of the present embodiment has a crank-like shape 901. The crank-like shape 901 is formed in the internal space of a fan-coupling member 26 connecting a ventilation member 101 on the intake side of the display module 13 to the fan 25. The crank-like shape 901 forms a pool in the flow path in the fan-coupling member 26. Foreign matter is deposited in the pool and therefore do not enter the display module 13.

Instead of the crank-like shape 901, any structure that can prevent entry of foreign matter into the display module 13 may be used, including a shape that causes stagnation, an adhesive member, a charging member, or a filter (for example, non-woven fabric) provided in the flow path. Further, these structures may be combined, and a filter may be provided between the crank-like shape 901 and the ventilation member 101, for example. In such a configuration, the filter collects less foreign matter and therefore less likely to be clogged. Additionally, a coarse filter may be used to increase the volume of air blown into the flow path. Further, a member for collecting dust, such as the crank-like shape 901, may be provided in the other embodiments described above. In this case, the member for collecting dust may be placed in a flow path connected to any section of the display module on the intake side. The flow path does not necessarily have to be connected to a ventilation member.

The present invention is not limited to the preferable embodiments described above, and various modifications and variations can be made within the scope of the invention.

The present invention efficiently dissipates heat in a display apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-012299, filed on Jan. 29, 2020, which is hereby incorporated by reference herein in its entirety.

What is claimed is:

1. A display apparatus comprising:
a display panel configured to transmit light applied to a back side thereof to display an image;
an optical member provided behind the back side of the display panel such that a first space is formed between the display panel and the optical member;
a light-emitting member provided behind a back side of the optical member to apply light to the back side of the display panel through the optical member; and
a flow-path forming member forming a flow path that allows air to flow from one of outside of the display apparatus and a part of the first space corresponding to at least one of four outer edges of the display panel to the other.

2. The display apparatus according to claim 1, wherein a second space is formed between the optical member and the light-emitting member, and
the flow-path forming member forms a flow path that allows air to flow from one of the outside of the display apparatus and a part of the second space corresponding to at least one of the four outer edges of the display panel to the other.

3. The display apparatus according to claim 1, further comprising a fan configured to discharge air from one of inside of the flow path and the outside of the display apparatus to the other.

4. The display apparatus according to claim 1, wherein a vent hole is provided to connect an internal space of the flow-path forming member to the part of the first space corresponding to the at least one of the four outer edges of the display panel.

5. The display apparatus according to claim 4, further comprising an opening and closing unit in the flow path configured to control opening and closing of the vent hole.

6. The display apparatus according to claim 1, wherein the flow-path forming member is (1) provided along one of an upper edge and a lower edge of the display panel and (2) provided along a left edge and a right edge of the display panel.

7. The display apparatus according to claim 6,
wherein the flow-path forming member provided along one of the upper edge and the lower edge of the display panel extends over an entire width from a left end to a right end of the display panel, and
wherein the flow-path forming members respectively provided along the left edge and the right edge of the display panel extend partially between a lower end and an upper end of the display panel.

8. The display apparatus according to claim 1, wherein the flow-path forming member is provided in plurality along a same edge among the four outer edges of the display panel.

9. The display apparatus according to claim 1, further comprising a partition provided in the flow path to partially reduce a size of the flow path.

10. The display apparatus according to claim 1,
wherein the flow-path forming member is provided inside an exterior member of the display apparatus so as to extend from a front side of the display apparatus toward a back side of the display apparatus, and
wherein a part of the flow path is formed between the exterior member and the flow-path forming member.

11. The display apparatus according to claim 10, wherein the flow-path forming member is provided such that a distance to the exterior member from the back side of the display apparatus is greater than a distance to the exterior member from the front side of the display apparatus.

12. The display apparatus according to claim 10, further comprising:
a panel-driving board connected to the display panel to drive the display panel; and
an electric board connected to the panel-driving board,
wherein the flow-path forming member comprises an insertion hole to insert a cable for connecting the panel-driving board to the electric board.

13. The display apparatus according to claim 1, further comprising a reflective member provided at least partially inside the flow path to reflect light.

14. The display apparatus according to claim 13, wherein the reflective member is provided inside the flow-path forming member.

15. The display apparatus according to claim 13,
wherein the reflective member is also provided in a second space between the optical member and the light-emitting member, and
wherein the reflective member provided inside the flow-path forming member is integral with the reflective member provided in the light-emitting member in the second space.

16. The display apparatus according to claim 1, further comprising a film reflective member provided in a second space to cover a vent hole connecting an internal space of the flow-path forming member to the second space between the optical member and the light-emitting member.

17. The display apparatus according to claim 1, further comprising:
(1) a first reflective member that is connected to the optical member and (2) a second reflective member that is connected to the light-emitting member and substantially parallel to the first reflective member, wherein the first reflective member and the second reflective member are provided between an internal space of the flow-path forming member and a second space between the optical member and the light-emitting member; and
wherein a gap flow path is formed between the first reflective member and the second reflective member to connect the second space to the internal space of the flow-path forming member.

18. The display apparatus according to claim 1, wherein a part of the flow path is formed by (1) the flow-path forming member, (2) a case holding a light-source board on which the light-emitting member is disposed, and (3) a section of the light-source board, wherein the section extending outward of an effective display area of the display panel.

19. The display apparatus according to claim 1, further comprising a partitioning portion that forms a crank-like shape in a flow path for sending air from outside of the display apparatus to inside of the display apparatus.

20. The display apparatus according to claim 1, further comprising one of an adhesive member and a charging member in a flow path for sending air from outside of the display apparatus to inside of the display apparatus.
